(19) United States
(12) Patent Application Publication
(10) Pub. No.: US 2011/0294638 A1
(43) Pub. Date: Dec. 1, 2011

(54) Assembly of a Cardboard Tray

(76) Inventor: Dimitri Tosevski, Epping (AU)

(21) Appl. No.: 13/126,869

(22) PCT Filed: Nov. 2, 2009
(86) PCT No.: PCT/AU09/01428

§ 371 Date: Aug. 15, 2011

(30) Foreign Application Priority Data
Oct. 31, 2008 (AU) 2008905653

(51) Int. Cl. B31B 3/26; B31B 1/50; B31B 1/06; B31B 1/12; B31B 3/44; B31B 3/02

(52) U.S. Cl. 493/123; 493/127; 493/137; 493/125; 493/167

(57) ABSTRACT

A machine to fold a cardboard blank into an open tray, the machine including means to displace a blank from a stack of blanks to a table, means to clamp the blank in a fixed position to the table, folding means to fold up sides and ends of the blank into vertically extending walls, consolidation means to urge overlapping flaps of the sides or ends into slots in the base of the blank and, means to eject the open tray from the machine.

### INTRODUCTION

This invention relates to a machine for assembling a cardboard tray.

### BACKGROUND OF THE INVENTION

Fruit and vegetables are frequently transported and sold in cardboard trays. These trays are usually open topped, rectangular structures made of corrugated cardboard. Sometimes the trays carry a lid otherwise and have a capacity to be stacked one on top of the other whilst containing fruit or vegetables.

The cardboard manufacturers produce blanks which can then be folded and usually glued in the corners to provide the completed tray. The folding operation is usually carried out in the factory that produces the cardboard and this has proved very inefficient due to the fact that a typical truck can carry 1,600 folded trays in contrast to about 10,000 flat trays.

Transporting blanks to the users of the trays solves the transportation problem but then those users have the problem of folding and assembling the trays. What is needed and currently not provided is a machine that can be positioned on the site of the users of the trays to quickly and efficiently fold blanks into trays.

It is these issues that have brought about the present invention.

### SUMMARY OF THE INVENTION

According to one aspect of the present invention there is a provided a machine to fold a cardboard blank into an open tray, the machine including means to displace a blank from a stack of blanks to a conveyor, the conveyor being adapted to transfer the blank to a table, the means to clamp the blank in a fixed position to the table, folding means to fold up sides and ends of the blank into vertical extending walls, consolidation means to urge overlapping flaps of the sides or ends into slots in the base of the blank and, a means to eject the open tray from the machine.

Preferably a series of pneumatic rams are used to effect the folding actions.

Preferably the timing of quotation of the pneumatic rams is controlled by a computer.

In a preferred embodiment the components of the machine are mounted on a free standing frame. Preferably the frame supports a compressor and the machine is adapted to be coupled to a source of single phase electricity to power the compressor and electrical components.

### DESCRIPTION OF THE DRAWINGS

An embodiment of the present invention will now be described by way of example only with reference to the accompanying drawings in which:

FIG. 1A is a plan view of a cardboard blank that can be folded into an open tray;

FIG. 1B is a detailed view of the blank within the circle 1B on FIG. 1A;

FIG. 1C is a perspective view showing the blank partially folded;

FIG. 1D is a perspective view of the blank when folded into the configuration of a tray;

FIG. 2A is a schematic side elevation view of a machine for folding blanks;

FIG. 2B is a side elevation view of the machine showing delivery of one blank;

FIG. 2C is a side elevation view of the machine showing the blank clamped to a folding station;

FIG. 2D is a section view taken along the lines B-B of FIG. 2C showing the blank in plan at the folding station;

FIG. 2E is an end elevation view of the blank at the folding station;

FIG. 2F is an end elevation view of the blank during a folding operation at the folding station;

FIG. 2G is a perspective view from the top showing the folding operation of FIG. 2F;

FIG. 2H is an enlarged view of a portion of the blank shown in the dotted circle in FIG. 2G;

FIG. 2I is a cross sectional view taken along the lines A-A of FIG. 2C showing blank whilst being folded;

FIG. 2J is an end elevation view of the folding operation;

FIG. 2K is an end elevation view of a consolidating operation;

FIG. 2L is a side elevation view of the machine showing a completed tray being ejected from the machine and the introduction of a new blank;

FIG. 3 is a detailed perspective view of the machine;

FIG. 4 is a detailed perspective view of the machine from the opposite side to FIG. 3;

FIG. 5 is a detailed side elevation view of the machine;

FIG. 6 is a sectional view taken along the lines C-C of FIG. 5 showing and end elevation of the machine;

FIG. 7 is an exploded view of a conveyor that forms part of the machine as well a pneumatic folding devices;

FIG. 8 are further perspective views of pneumatic folding devices;

FIG. 9 is a perspective view of a further folding device; and

FIG. 10 is a perspective view from the under side of the machine showing a clamping arrangement.

### DESCRIPTION OF THE PREFERRED EMBODIMENT

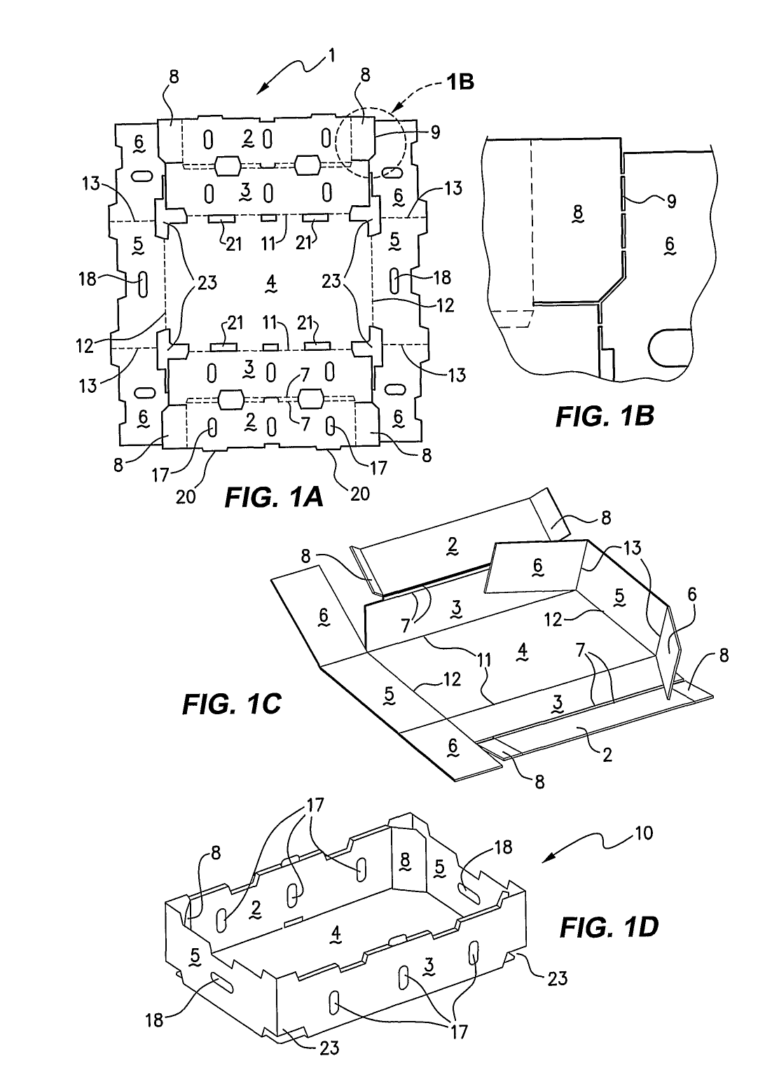

The blank 1 shown in FIG. 1 is constructed of corrugated cardboard with appropriate cut outs and fold lines to facilitate assembly into an open tray 10 shown in FIG. 1D. The tray 10 has ends 5, longer sides 3 and a base 4. The tray 10 is open topped as shown in FIG. 1D. The sides 3 of the blank are each formed by side flaps 3 and 2 joined by closely spaced parallel fold lines 7. Each side 3 folds about the base 4 along fold lines 11. The ends 5 comprise a central end flap with lateral end flaps 6. The central end flap 5 folds about the base 4 along the fold line 12 and the lateral end flaps 6 are arranged to fold relative to the central flap 5 about fold lines 13. The lateral end flaps 6 are joined to the side sub flaps 8 via a tear line 9 shown in FIG. 1B so that during assembly the end flaps 6 can be separated from the side sub flaps 8 during the following operation. The sides 3 have three spaced elongate holes 17 and the ends 5 to a single elongate hole 18. The base 4 has rectangular cut outs 21 adapted to received projections 20 on the edges of the outer flaps 2. Each corner of the base 4 has a cut out 23 that merges into the side and end flaps.

The blank is designed so that it can be folded to assume the completed form shown in FIG. 1D. The side flaps 2 and 3, are arranged to fold on top of each other to form a double wall structure and the projection 20 on the extremities of the side flap 2 are arranged to locate within slots 21 formed in the base 4. The end flaps 5 turn upwardly relative to the base as do the side flaps and the outer end flaps 6 located between the overlapping side flaps to hold the ends into the sides. The overlapping side flaps terminate in small sub flaps 8 which locate across the corners of the box and can be consolidated into the corners to assume the position shown in FIG. 1D. In this manner, the box 10 assumes a stable configuration without the need for adhesives.

The completed box 10 shown in FIG. 1D also has openings 23 in the base of each corner, holes 17 along the longer sides, and a single hole 18 on the ends. The upper profile of the box is stepped, as shown in FIG. 1D, and the box is designed so a plurality of boxes can be stacked on top of each other with the holes in the corners locating on the top of the columns formed by each corner. The blank 1 described above is designed so that it can be folded into a stable open tray 10 without the need for adhesive or other fasteners.

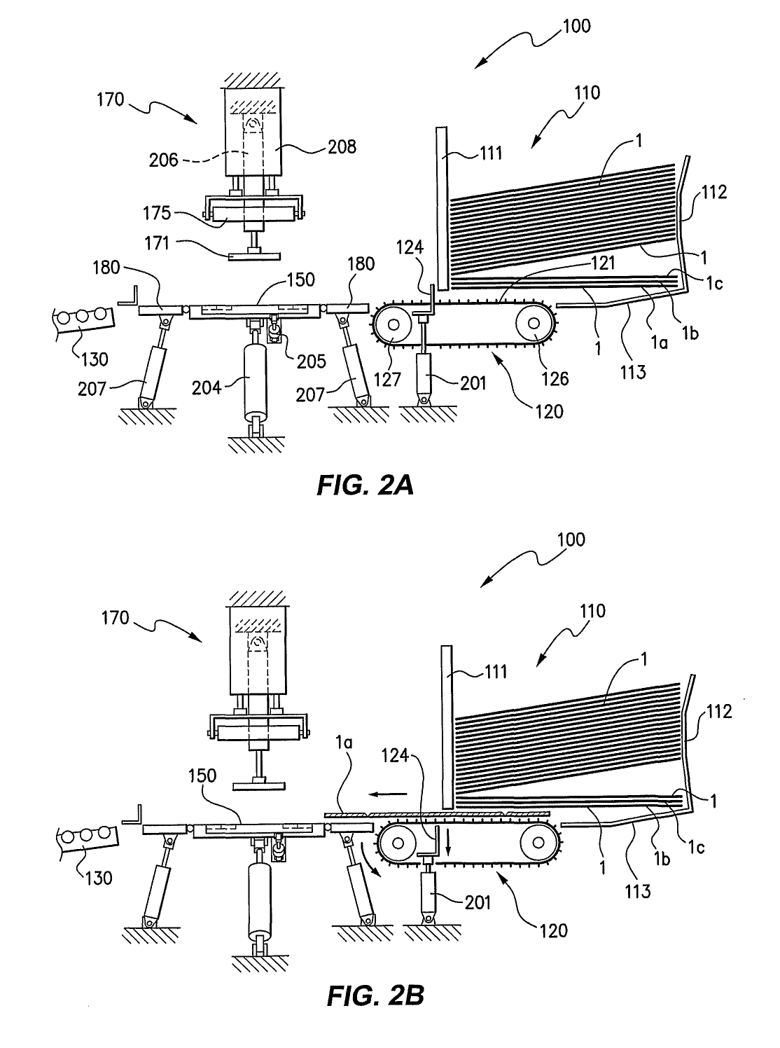

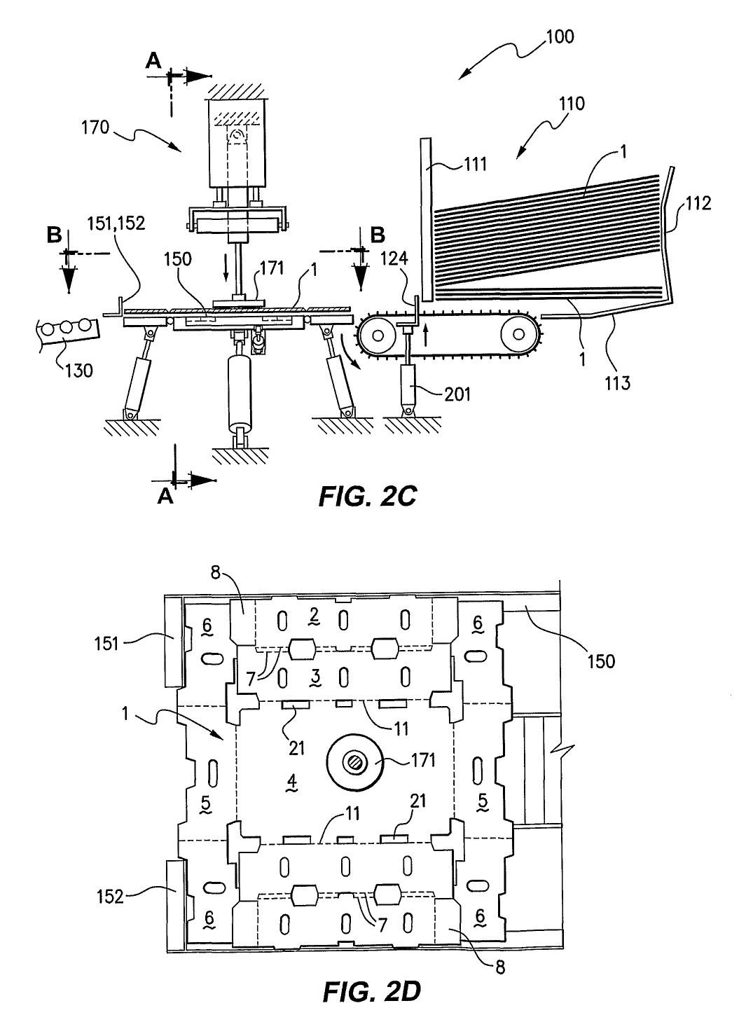

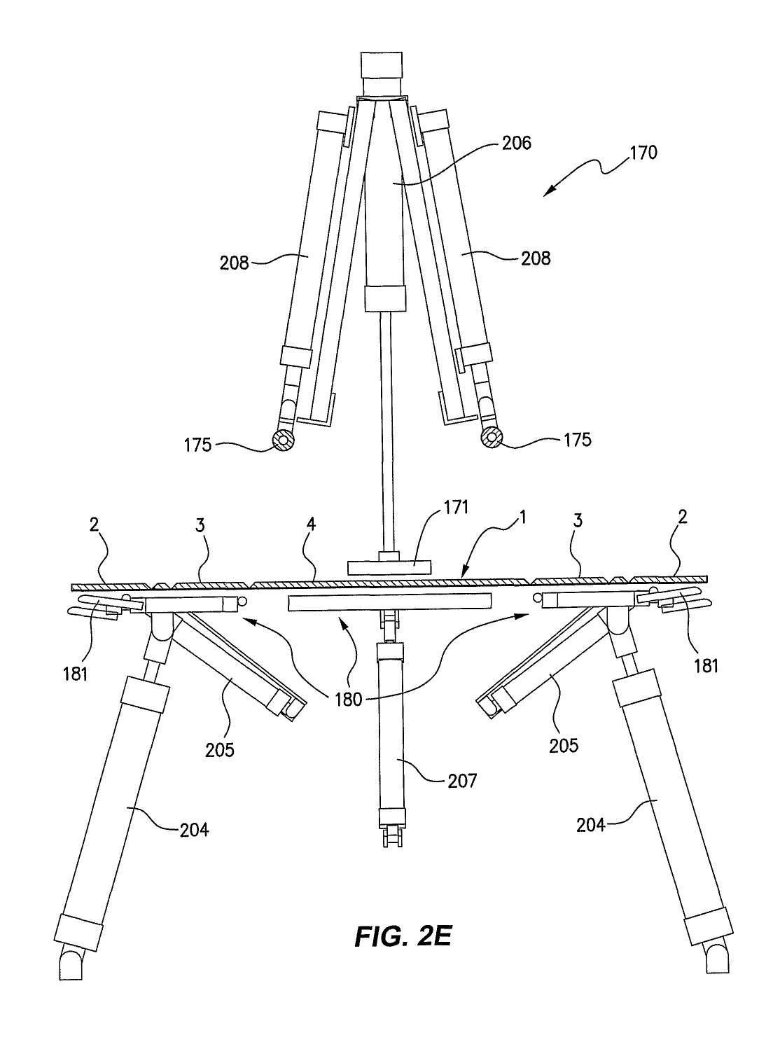

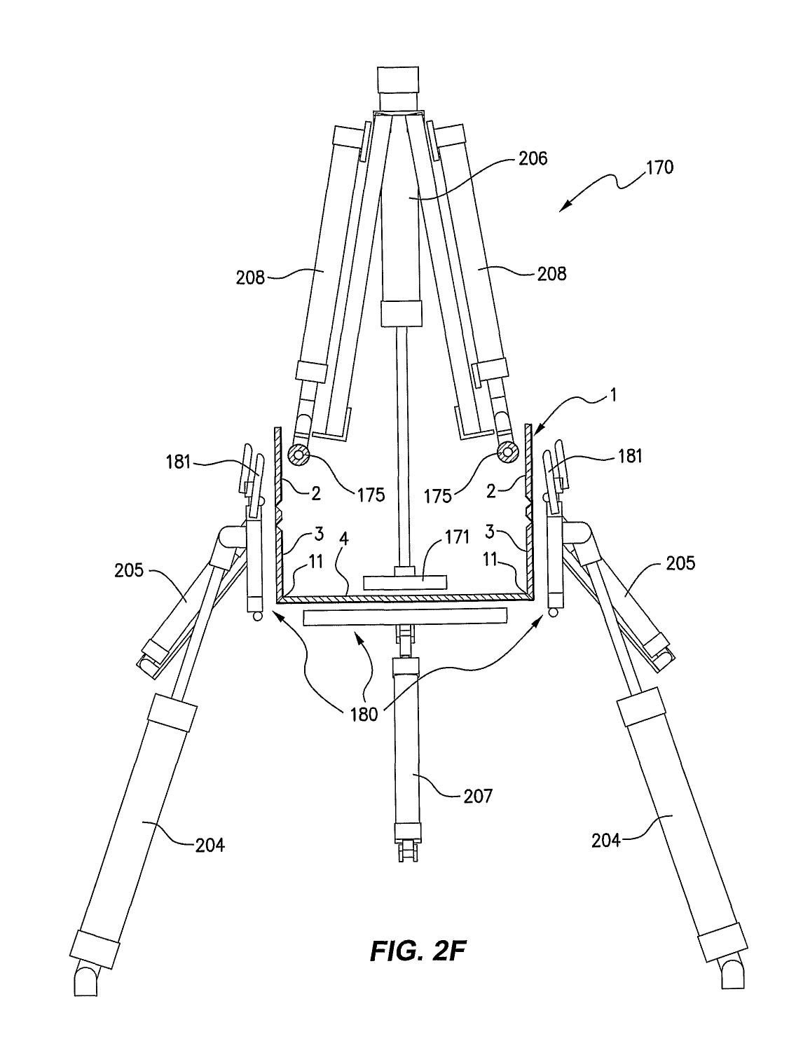

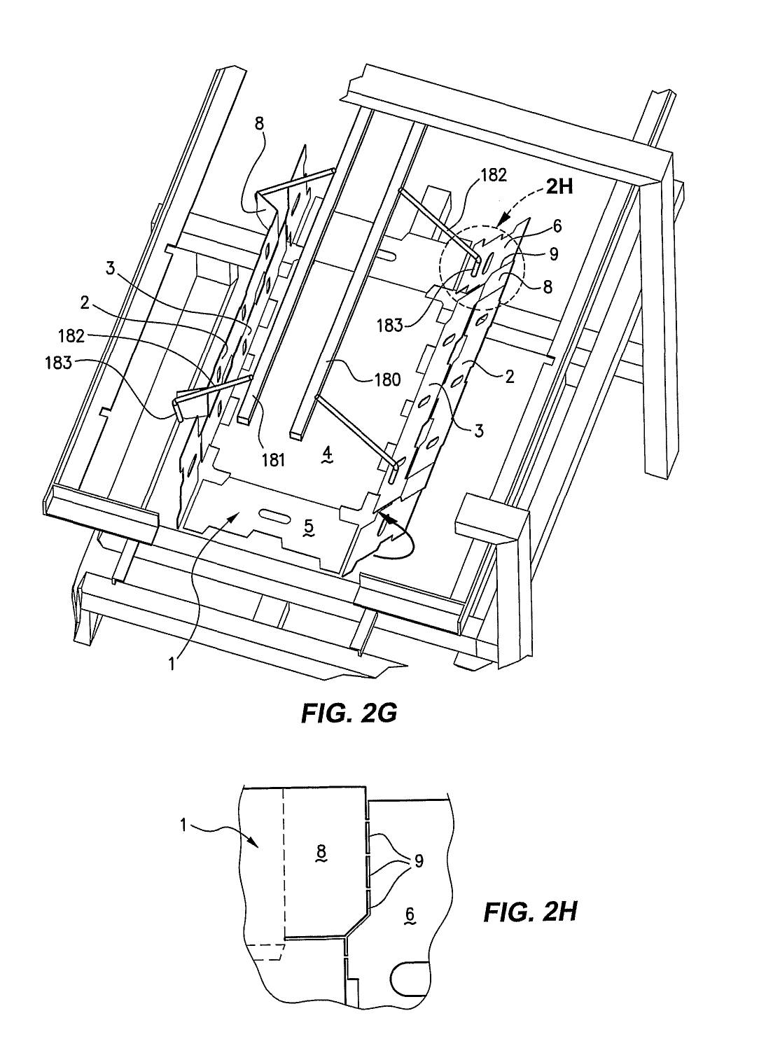

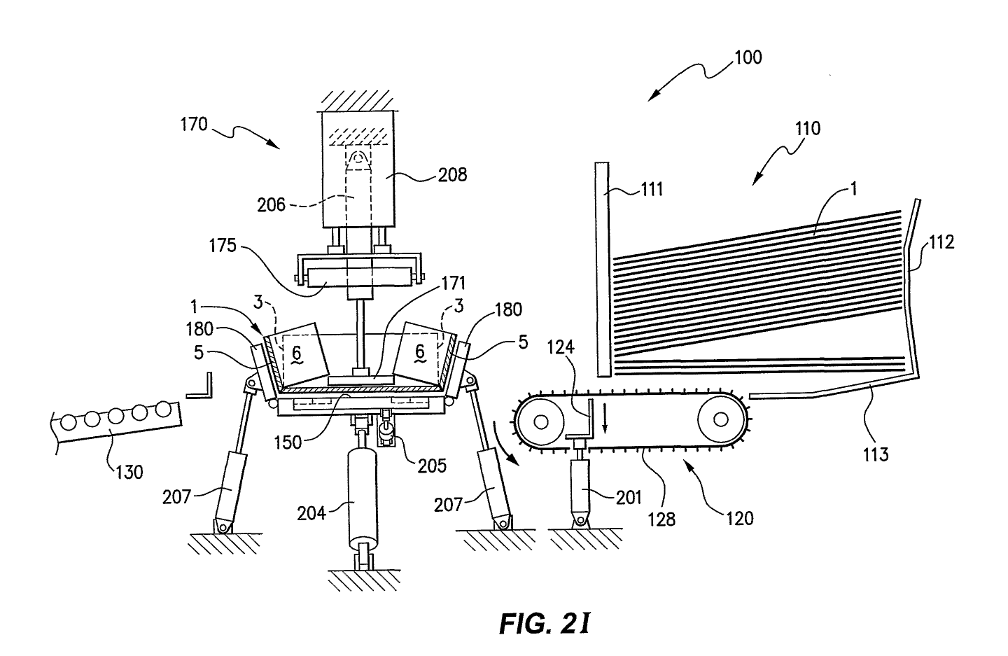

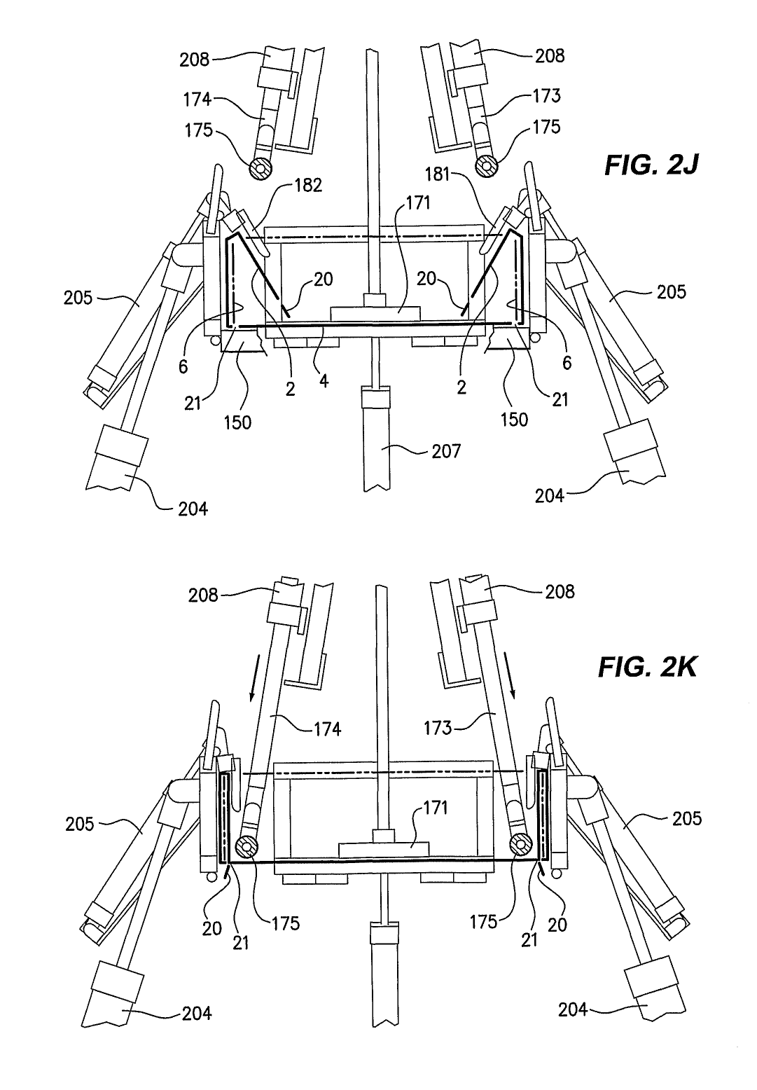

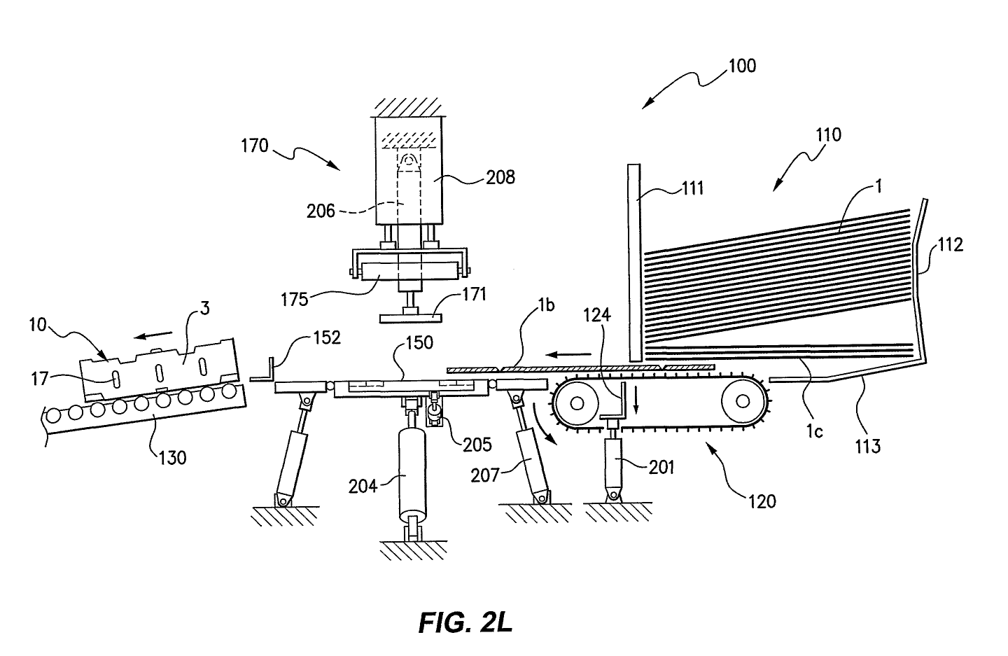

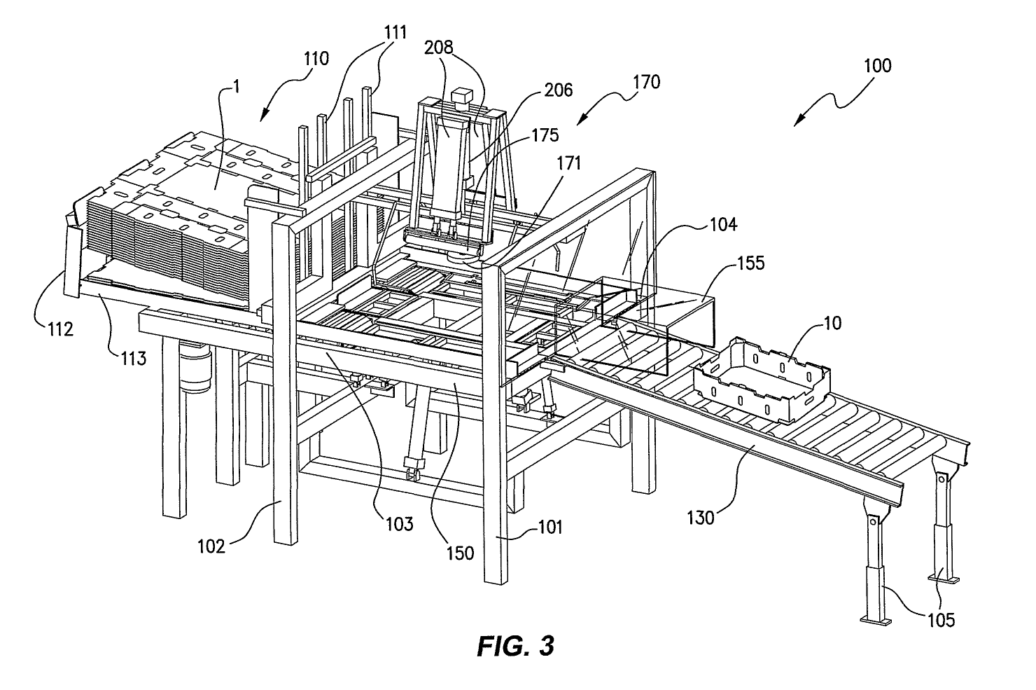

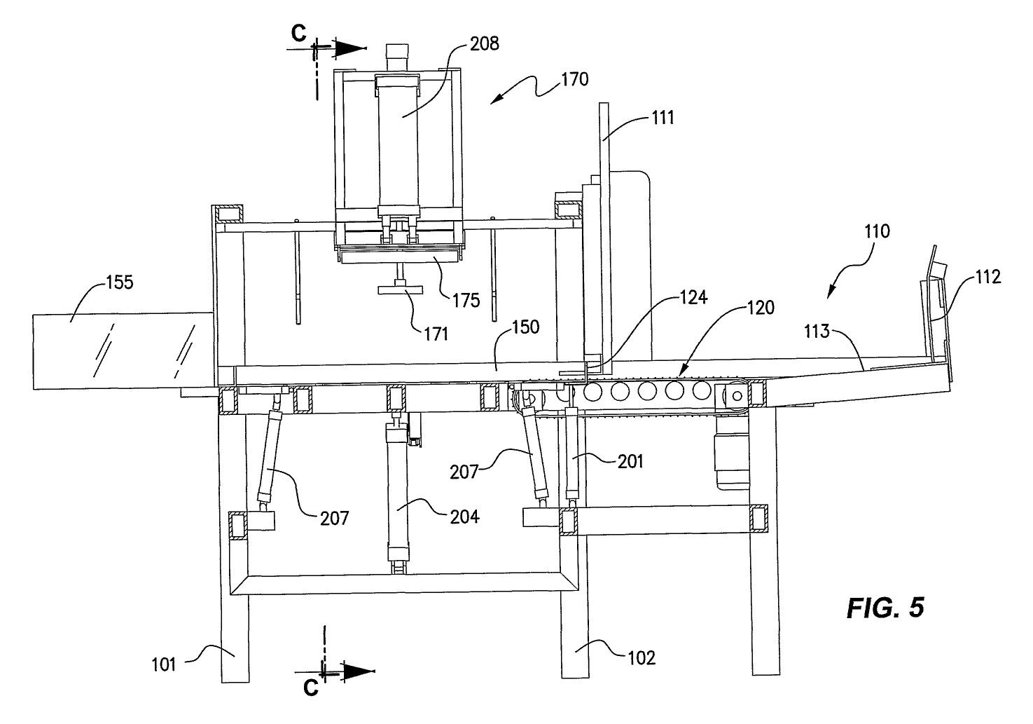

FIGS. 3 to 10 illustrate a machine for folding the blank and the folding process is illustrated in FIGS. 2A to 2L.

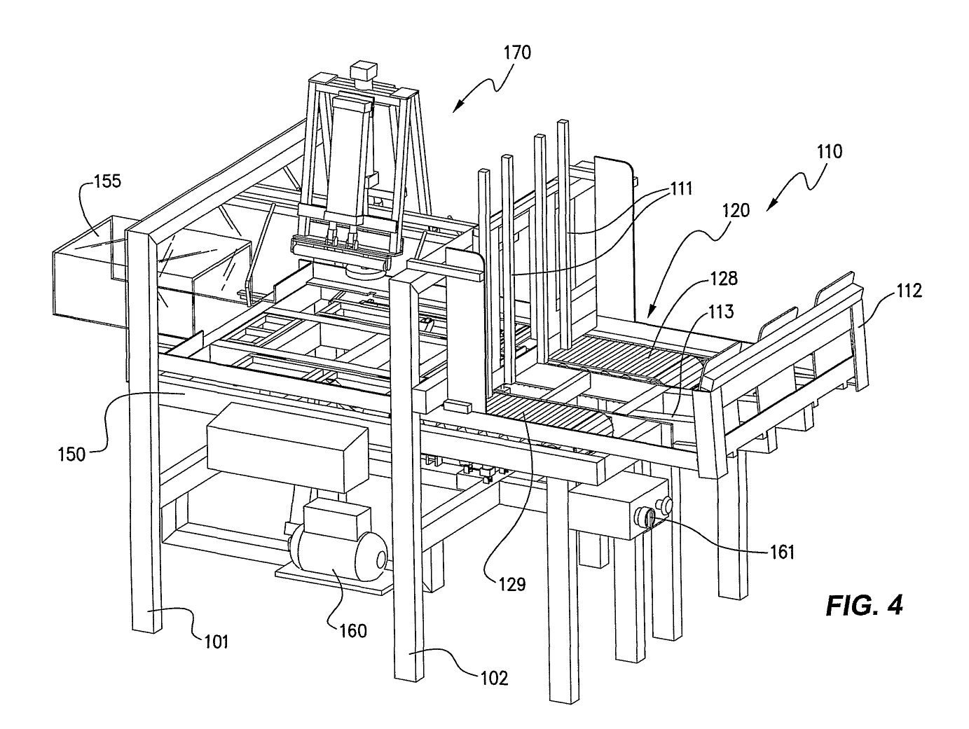

FIGS. 3 and 4 illustrate the machine 100 from which it can be seen that the machine 100 is free standing on a framework of rectangular metal beams welded together to define two major U-shaped uprights 101, 102 joined by cross members 103, 104, the uprights supporting a table 150 which extends outwardly to one side of the frame which in turn supports a stacking mechanism 110 and delivery conveyor 120. The other side of the frame supports a downwardly extending roller conveyor 130, the inclination of which is adjustable by adjustable legs 105 at one end.

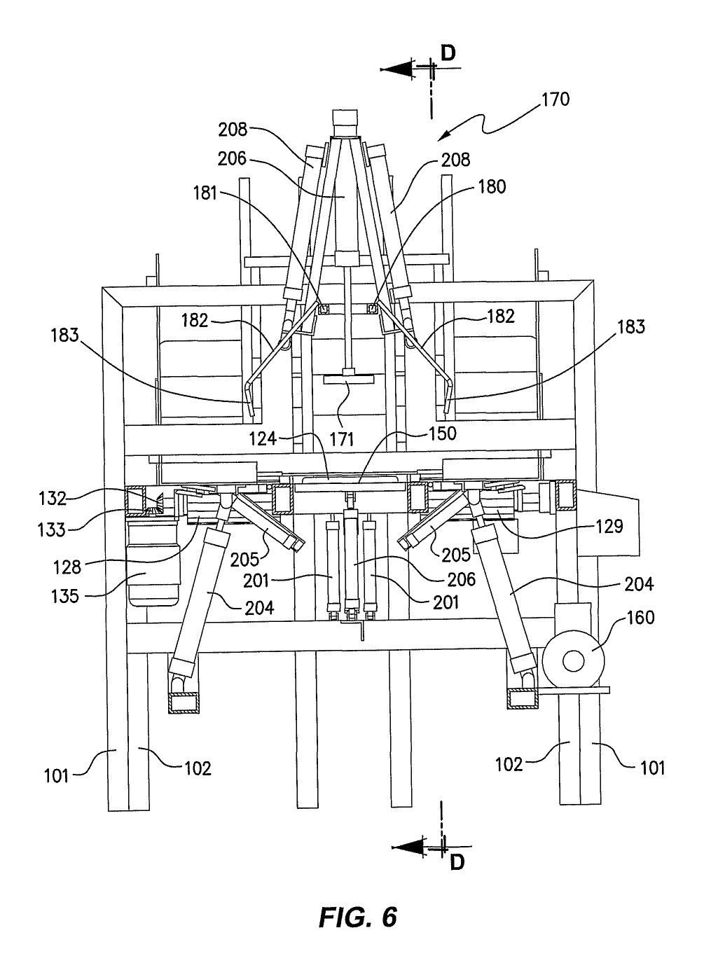

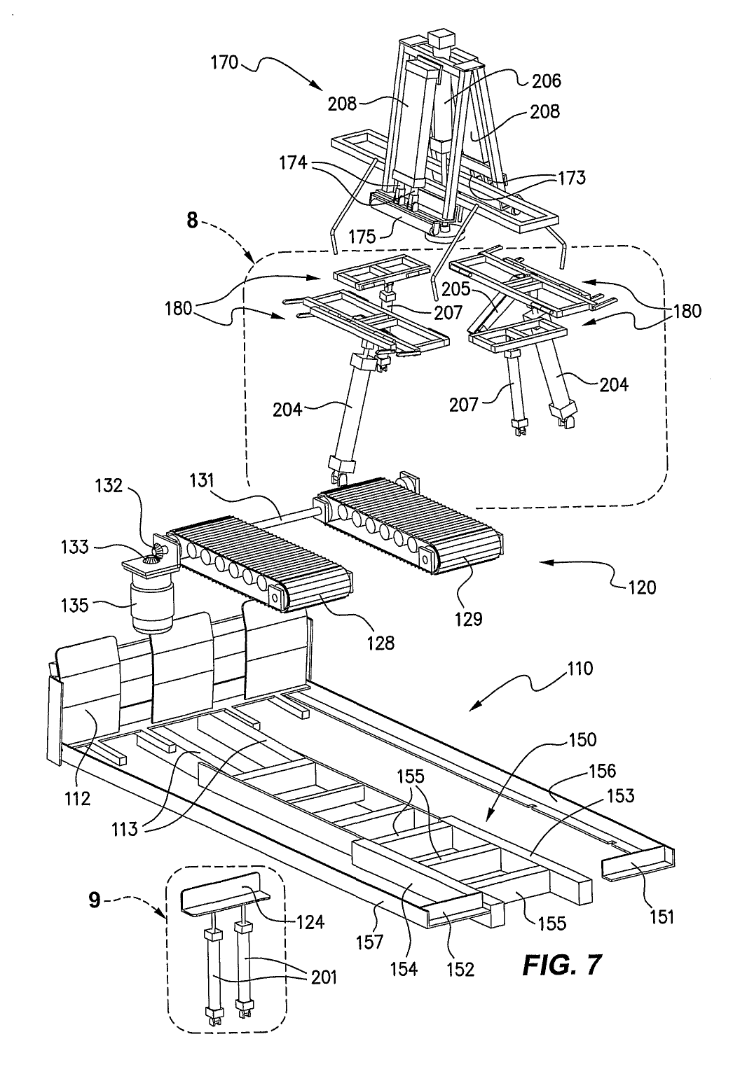

A Perspex rectangular housing 155 is positioned at the top of the roller conveyor 130 to direct a completed box 10 from the table 150 and down the conveyor. An overhead gantry 170 is positioned between the two frame members 101, 102, the gantry 170 including two consolidating rollers 175 and a central pressing member 171. The delivery conveyor 120 comprises two belt conveyors 128, 129 in a parallel spaced apart manner as shown in FIGS. 6 and 7. The belts 128, 129 are driven by a shaft 131 through gears 132, 133 driven by an electric motor 135. The frame of the machine also supports an air compressor 160 and an on/off switch 161, see FIG. 4. The compressor and electric motors can be powered by single phase mains electricity to increase the versatility of use of the machine.

Operation of the machine 100 is shown schematically in FIG. 2. The stacking mechanism 110 supports a stack of blanks 1 which are fed individually by the delivery conveyor 120 to the folding table 150. The exit conveyor 130 is positioned on the other side of the folding table 150 onto which the completed folded box 10 is ejected from the machine. Positioned adjacent the folding table 150 is the overhead clamping and folding gantry 170 and a series of folding arms 180 that have the effect of folding upwardly and inwardly the ends and side flaps 2, 3 to form the end and side walls of the box. A series of appropriately positioned pneumatic rams 201-208 driven from the compressor 160 are positioned throughout the machine to effect the folding, clamping and consolidating steps. FIGS. 7 to 9 show details of the overhead gantry 170, folding arms 180 and delivery conveyor 120.

As shown in FIG. 2 the stacking mechanism 110 has a vertical end wall 11 on one side and a right angled wall 112 and floor 113 on the opposite side with the floor being at a level below the upper surface 121 of the conveyor 120. A gate 124 is positioned outside the wall 111 and is vertically displaceable by a pneumatic ram 201 to drop below the upper surface of the conveyor to release the lowest blank. Three blanks 1a, b, c are held in this horizontal manner and the remaining blanks 1 are wedged at an incline as shown in FIGS. 2A and 2B. When the gate 124 is lowered by the pneumatic ram 201, the lowest blank on the surface of the conveyor 120 is fed under the end wall 111 and on to the fixed folding table 180, the feeding motion is shown in FIG. 2B.

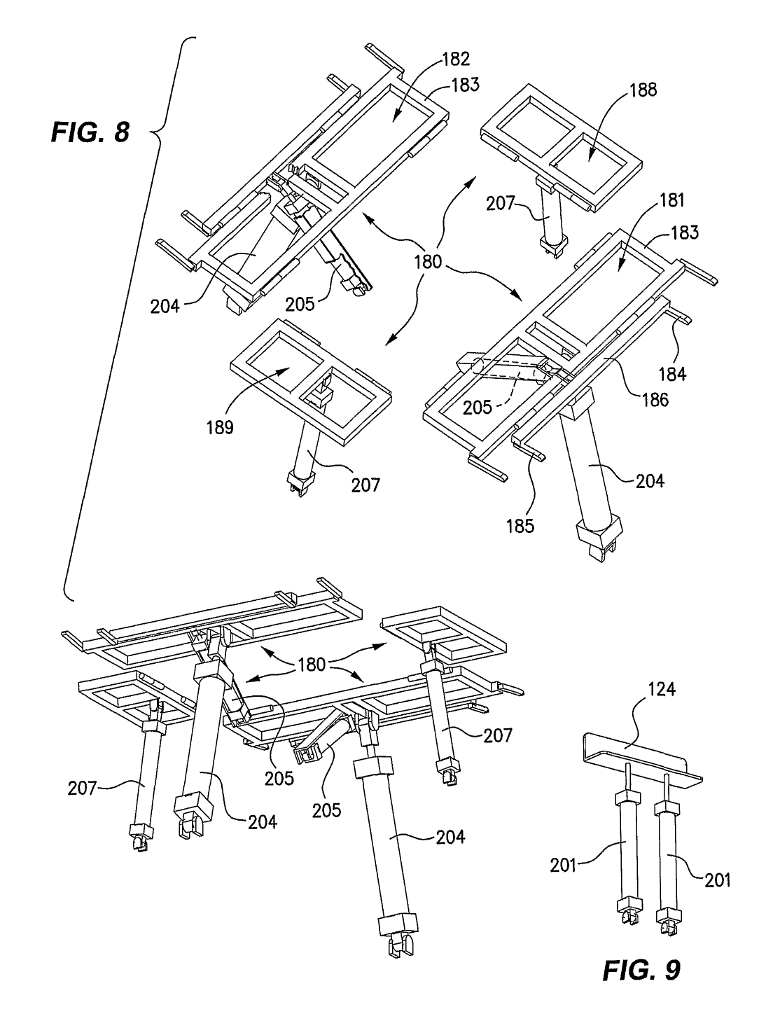

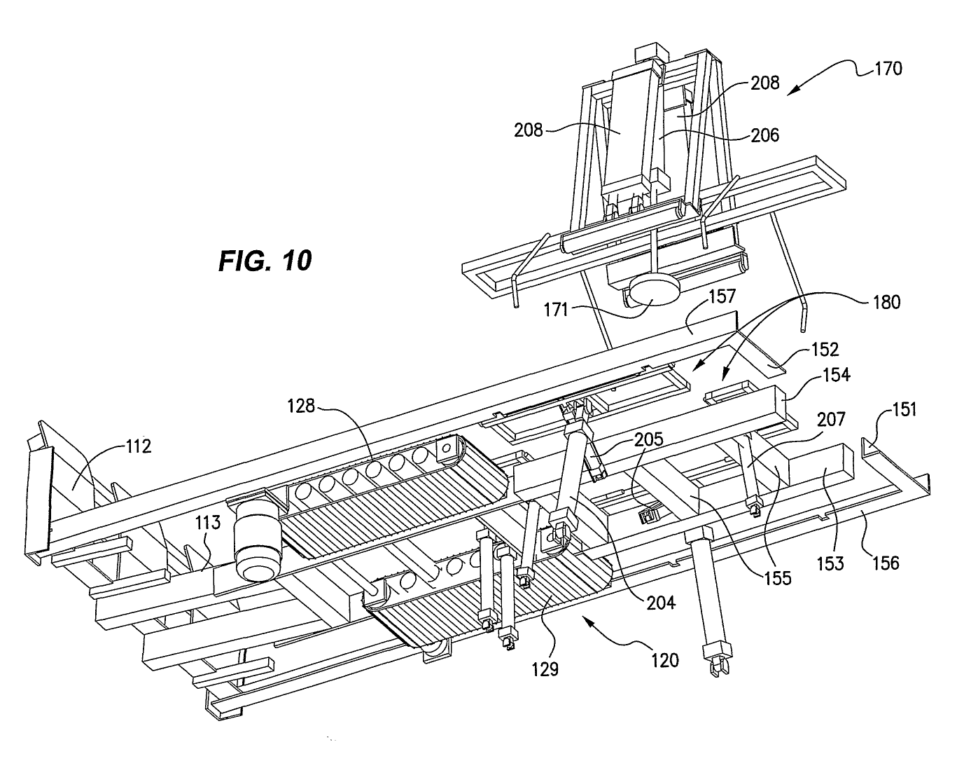

FIG. 2C shows the blank 1 positioned centrally on the folding table 150 with the gate 124 raised to prevent a second blank from moving onto the table. At this time a pneumatic ram 202 in the overhead gantry 170 lowers the pressing member 171 that engages the centre of the blank 1 as shown in FIG. 2D. In this way the blank is held firmly positioned on the table 150. The table 150 is shown in FIG. 10 and comprises spaced rails 153, 154 joined by spaced cross members 155. The edges of the table comprise angled beams 156, 157. The folding arms 180 shown in detail in FIG. 8 operate to extend through the gaps in the table 150. A pair of right angled brackets 151, 152 are positioned at the far end of the table 150 against which the blank 1 engages to determine the position of the blank 1 on the table 150 prior to the lowering of the pressing member 171.

The folding arms 180 are shown in greater detail in FIG. 8. The pair of opposed side folding arms 181, 182 each comprise a rectangular flap 183 driven by a ram 204. A pair of consolidating fingers 184, 185 are connected on a bar 186 to pivot about the rectangular plate 183. The fingers are driven by the subsidiary ram 205. Mounted at 90° to the side folding arms are end folding arms 188, 189 that are in turn driven by pneumatic rams 207.

FIG. 2E shows the folding arms 180 ready to fold up the sides of blank. The substantially vertically extending pneumatic rams 204 are connected to the folding arm 180 that sits under the side panels 3 and the subsidiary pair of rams 207 angled at 45 degrees have a projecting hand 181 located underneath the outer panels 2. When the pneumatic rams 204 are activated as shown in FIG. 2F, the side panels 3 are folded upwardly about the fold lines 11 to assume a vertical configuration.

To ensure that the blank 1 shown in FIG. 1 always remains flat in a stacked configuration, it is important that the side and edge flaps are joined. It is for this reason that the tear line 9 shown in FIG. 1B is provided between the lateral end flap 6 and the side sub-flaps 8. This ensures that the blanks remain flat and do not impede one another when stacked in the stacking mechanism 110 at the start of the machine.

FIGS. 2G and 2H illustrate a mechanism for causing the end flap 6 and the side sub-flaps 8 to separate about the tear line 9. A pair of rectangular bars each carrying downwardly extending fingers that have in-turned ends that are adapted to engage within apertures in the end flaps 6. As the sides are folded up, the engagement of the fingers against the inner surface of the end flaps 6 caused the fold lines 9 to break and allows the end flaps to be pivoted upwardly relative to the side sub-flaps 8. This is shown with particular reference to the left hand side of FIG. 2G.

FIG. 2I which is a view 90° to the view of FIG. 2F, shows pneumatic rams 207 pushing up the end flaps 5 inside the upwardly standing side flaps 3.

FIG. 2J which is a view 90° to FIG. 2I, shows the auxiliary rams 207 and hands 181 forcing the outer flaps 2 of the side flaps 3 over on to the in turned flap 6 of the end flaps 5 so that the sides end up in effect with a triple walled structure.

In FIG. 2K, consolidators 173, 174 in the form of elongate rollers 175 on a ram 208 move down to push the overturned flaps 2 against the side walls 3 with the projections 20 on the flaps being pushed through the rectangular apertures 21 in the base 4 to consolidate the side walls 3 over the in turned flaps 6 of the end walls 5 as shown in FIG. 2K. In this position, the assembly of the box 10 is complete because the side walls 3 and end walls 5 have been locked together and they are held in position by the location of the lugs 20 through the rectangular apertures 21. The pressing member 171 is then lifted.

FIG. 2M then shows the completed box 10 being ejected on to the downwardly inclined conveyor 130 with a new blank 1b being transferred from the stack 110 to the folding table 150.

It is understood that the synchronisation of the machine and the operation of all the pneumatic rams is controlled by a computer and the machine includes a control panel (not shown) from which an operator can control and vary the timing of the operations steps. Further details of the conveyors and the folding rams are shown with particular reference to FIGS. 7, 8 and 9.

The machine described above is designed to be used on site, that is, on the site where the boxes are actually used to contain fruit or vegetables. By supplying machines to the end users there is then the opportunity of supplying the boxes in a flat configuration, having the boxes assembled on site and then, when necessary, returning the boxes again in a flat configuration. This is a far more efficient way of transporting boxes than would be the case if the boxes were transported erected.

The machine has the capacity to fold a box every five seconds so there is no problem with the machine supplying the demand on site. The absence of glue or fasteners means that the box can be erected in a simple manner and then dismantled to again form a flat sheet with a minimum of effort and without the need for specific tools. This also increases the reusability of the boxes and renders the process more ecologically acceptable than current methods where boxes get damaged and destroyed and are seldom reused.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A machine to fold a cardboard blank into an open tray, the machine including means to displace a blank from a stack of blanks to a table, means to clamp the blank in a fixed position to the table, folding means to fold up sides and ends of the blank into vertically extending walls, consolidation means to urge overlapping flaps of the sides or ends into slots in a base of the blank and, means to eject the open tray from the machine.

2. The machine according to claim 1 wherein a series of pneumatic rams are used to effect the folding actions.

3. The machine according to claim 2 wherein timing of operation of the pneumatic rams is controlled by a computer.

4. The machine according to claim 1 wherein the means to displace, means to clamp, folding means, consolidation means and means to eject are mounted on a free standing frame and are driven by a compressor supported on the frame.

5. The machine according to claim 4 wherein the machine is adapted to be coupled to a source of single phase electricity to power the compressor and electrical components.

6. The machine according to claim 1 wherein a conveyor transfers the blank to the table.

7. The machine according to claim 1 wherein the means to clamp and the consolidation means are mounted on a gantry above the table.

8. The machine according to claim 7, wherein the gantry supports a pneumatic ram that drives the means to clamp to hold the blank on the table.

9. The machine according to claim 1 wherein the consolidation means comprises a pair of rollers urged by pneumatic rams to push down onto edges of the folded sides.

10. The machine according to claim 1 wherein the folding means includes a first folding mechanism to fold up the sides of the blank, and a second folding mechanism to fold up the ends of the blank, the first folding mechanism including an additional folding means to fold over the top of the sides to constitute the overlapping flaps.
